(19) United States
(12) Patent Application Publication
(10) Pub. No.: US 2008/0187000 A1
(43) Pub. Date: Aug. 7, 2008

(54) APPARATUS AND METHOD FOR GENERATING SUBCHANNELS IN A COMMUNICATION SYSTEM

(75) Inventors: Tae-Young KIM, Seongnam-si (KR); Jeong-Ho PARK, Seoul (KR); Jae-Hee CHO, Seoul (KR); Kwan-Hee ROH, Hwaseong-si (KR); Jae-Weon CHO, Suwon-si (KR); Jin-Kyu KOO, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/024,272

(22) Filed: Feb. 1, 2008

(30) Foreign Application Priority Data
Feb. 2, 2007 (KR) 2007-11094

(51) Int. Cl. H04J 3/16; H04J 3/22

(52) U.S. Cl. 370/465; 370/203

(57) ABSTRACT

An apparatus and method for generating subchannels in a communication system are provided. An apparatus and method of the invention includes a Base Station (BS) in which the BS groups J slots included in a subchannel generation zone into I groups, selects, from the J slots, M band-Adaptive Modulation and Coding (AMC) slots with which it will generate a band-AMC subchannel, selects (J-M) slots as diversity slots with which it will generate a diversity subchannel, generates the band-AMC subchannel using the M slots and generates the diversity subchannel using the (J-M) slots.

### PRIORITY

This application claims the benefit under 35 U.S.C. § 119(a) of a Korean Patent Application filed in the Korean Intellectual Property Office on Feb. 2, 2007 and assigned Serial No. 2007-11094, the entire disclosure of which is hereby incorporated by reference.

### BACKGROUND OF THE INVENTION

1. Field of the Invention

The present invention relates to an apparatus and method for a communication system. More specifically, the present invention relates to an apparatus and method for generating subchannels in a communication system.

2. Description of the Related Art

In general, next-generation communication systems are being developed to provide Mobile Stations (MSs) with services capable of high-speed and high-capacity data transmission/reception. Typical examples of the next-generation communication systems include an Institute of Electrical and Electronics Engineers (IEEE) 802.16 communication system, a Mobile Worldwide Interoperability for Microwave Access (Mobile WiMAX) communication system and an IEEE 802.20 communication system, i.e., Mobile Broadband Wireless Access (MBWA) communication system. Among others, the Mobile WiMAX communication system is a communication system that uses the IEEE 802.16 standard similar to the IEEE 802.16 communication system. The Mobile WiMAX communication system, the IEEE 802.16 communication system and the IEEE 802.20 communication system are communication systems using any one of an Orthogonal Frequency Division Multiplexing (OFDM) scheme and an Orthogonal Frequency Division Multiple Access (OFDMA) scheme. For convenience, it will be assumed herein that the Mobile WiMAX communication system, the IEEE 802.16 communication system, and the IEEE 802.20 communication system use the OFDMA scheme and the communication system using the OFDMA scheme will be referred to as an ‘OFDMA communication system’.

With reference to FIG. 1, a description will now be made of a configuration of a conventional IEEE 802.16 communication system.

FIG. 1 schematically illustrates a configuration of a conventional IEEE 802.16 communication system.

Referring to FIG. 1, the IEEE 802.16 communication system has a multi-cell configuration. That is, the system includes a cell 100 and a cell 150. The system further includes a Base Station (BS) 110 in charge of the cell 100, a BS 140 in charge of the cell 150, and multiple MSs 111, 113, 130, 151 and 153.

In the IEEE 802.16 communication system, subchannels are classified into band-Adaptive Modulation and Coding (AMC) subchannels and diversity subchannels according to their subchannel generation scheme. A description will now be given of the band-AMC subchannels and the diversity subchannels.

### Band-AMC Subchannel

The full frequency band used in the IEEE 802.16 communication system is divided into multiple subbands, i.e., multiple bands. At least one subcarrier in each of the multiple bands is generated as one band-AMC subchannel. The subcarriers included in the band-AMC subchannel are subcarriers physically neighboring each other. To generate the band-AMC subchannel in this way, a BS should receive Channel Quality Information (CQI) feedback for each of the multiple bands from each of MSs located in its coverage. The BS generates band-AMC subchannels belonging to the band over which it can provide the optimal channel state to each of the MSs, taking into account the CQI feedback received from each of the MSs. In this case, the band-AMC subchannels in each band may have similar channel states to each other, since they are composed of subcarriers physically neighboring each other. Therefore, the MS can maximize its transmission capacity as it can use an AMC scheme suitable for each band-AMC subchannel.

### Diversity Subchannel

The diversity subchannel is generated in such a manner that at least one subcarrier among all subcarriers used in the IEEE 802.16 communication system is distributed over the full frequency band used in the IEEE 802.16 communication system. That is, the diversity subchannel is a subchannel generated to ensure the capability of acquiring frequency diversity gain. Generally, wireless channels undergo various changes in a time domain and a frequency domain. When the channel states change variously in this way, it is impossible for the BS to adaptively transmit signals according to the channel state of a particular MS. That is, even though a BS normally transmits signals to an MS, the MS may sometimes receive the signals in a good channel state and sometimes in a poor channel state according to the time where the BS transmitted the signals. When the channel states change variously with the passage of time in this way, it is generally preferable for the MS to acquire diversity gain, so the BS determines a subchannel to be allocated to the MS, as a diversity subchannel.

To generate the band-AMC subchannels and the diversity subchannels, the IEEE 802.16 communication system uses a multi-zone structure within a frame. A description of the multi-zone structure will now be given below. The term ‘multi-zone structure’ as used herein refers to a structure in which a band-AMC subchannel zone and a diversity subchannel zone are separated in the time domain according to a Time Division Multiplexing (TDM) scheme. Band-AMC subchannels are generated in the band-AMC subchannel zone, and diversity subchannels are generated in the diversity subchannel zone. However, in the case where a length of the frame used in the IEEE 802.16 communication system is relatively short, if the system generates band-AMC subchannels and diversity subchannels using the multi-zone structure, it is not possible to generate the band-AMC subchannels and the diversity subchannels with desired ratios.

Furthermore, the IEEE 802.20 communication system does not support a separate zone structure for generating the band-AMC subchannels and the diversity subchannels. Rather, the IEEE 802.20 communication system supports a structure in which either of only the band-AMC subchannels or only the diversity subchannels is generated in the same frame. Therefore, in the IEEE 802.20 communication system, it is impossible for the BS to generate the band-AMC subchannels and the diversity subchannels in the same frame.

As described above, neither the IEEE 802.16 communication system nor the IEEE 802.20 communication system can simultaneously generate the band-AMC subchannels and the diversity subchannels in the same zone.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for generating subchannels in a communication system.

Another aspect of the present invention is to provide an apparatus and method for generating band-AMC subchannels and diversity subchannels in the same zone in a communication system.

According to one aspect of the present invention, an apparatus for generating a subchannel in a communication system is provided. The apparatus includes a Base Station (BS) for grouping J slots included in a subchannel generation zone into I groups, for selecting, from the J slots, M band-Adaptive Modulation and Coding (AMC) slots with which a band-AMC subchannel is to be generated, for selecting J-M slots as diversity slots with which a diversity subchannel is to be generated, for generating the band-AMC subchannel using the M slots and for generating the diversity subchannel using the J-M slots.

According to another aspect of the present invention, a method for generating a subchannel in a communication system is provided. The method includes grouping J slots included in a subchannel generation zone into I groups, selecting, from the J slots, M band-Adaptive Modulation and Coding (AMC) slots with which a band-AMC subchannel is to be generated, selecting J-M slots as diversity slots with which a diversity subchannel is to be generated, generating the band-AMC subchannel using the M slots and generating the diversity subchannel using the J-M slots.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following description taken in conjunction with the accompanying drawings in which:

FIG. 1 is a diagram schematically illustrating a configuration of a conventional IEEE 802.16 communication system;

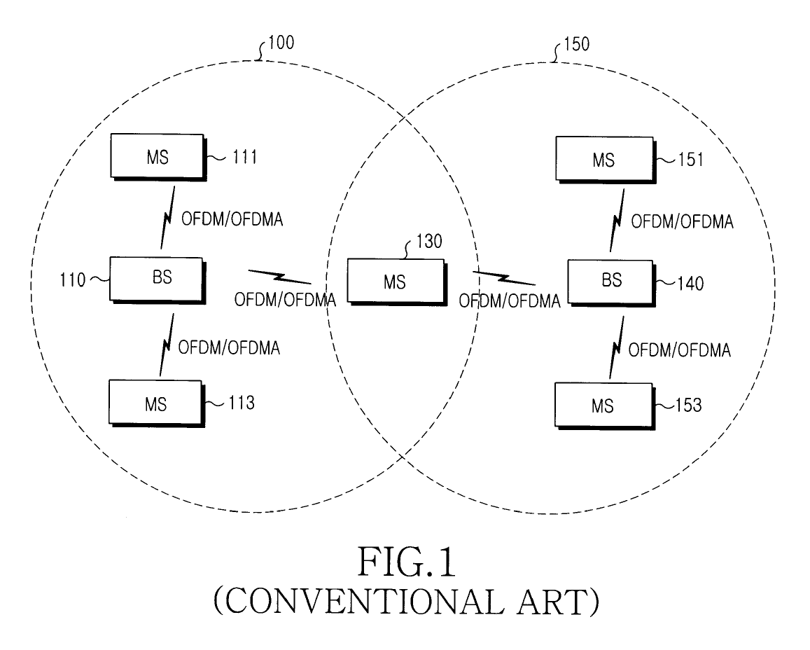

FIG. 2 is a flowchart illustrating a process of generating subchannels at a BS in an OFDMA communication system according to an exemplary embodiment of the present invention;

FIG. 3 is a flowchart illustrating an exemplary operation of step 217 in FIG. 2;

FIG. 4 is a flowchart illustrating an exemplary operation of step 219 in FIG. 2; and

FIG. 5 is a diagram illustrating a process in which a BS generates a subchannel in an OFDMA communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an apparatus and method for generating subchannels in a communication system. Further, exemplary embodiments of the present invention provide an apparatus and method for generating subchannels in a communication system using an Orthogonal Frequency Division Multiple Access (OFDMA) scheme (hereinafter referred to as an ‘OFDMA communication system’) such as an Institute of Electrical and Electronics Engineers (IEEE) 802.16 communication system, a Worldwide Interoperability for Microwave Access (Mobile WiMAX) communication system and an IEEE 802.20 communication system, i.e., Mobile Broadband Wireless Access (MBWA) communication system. In addition, exemplary embodiments of the present invention provide an apparatus and method for generating band-Adaptive Modulation and Coding (AMC) subchannels and diversity subchannels in the same zone in an OFDMA communication system.

Although a subchannel generation method proposed by the present invention is not separately illustrated, it will be assumed that the subchannel generation method is performed by a subchannel generation apparatus, for example, a Base Station (BS), of the OFDMA communication system. Furthermore, while the description of an exemplary subchannel generation apparatus and method will be made herein with reference to the OFDMA communication system, this is merely for convenience and it is to be understood that the exemplary subchannel generation apparatus and method proposed by the present invention can be applied not only to the OFDMA communication system but also to other communication systems.

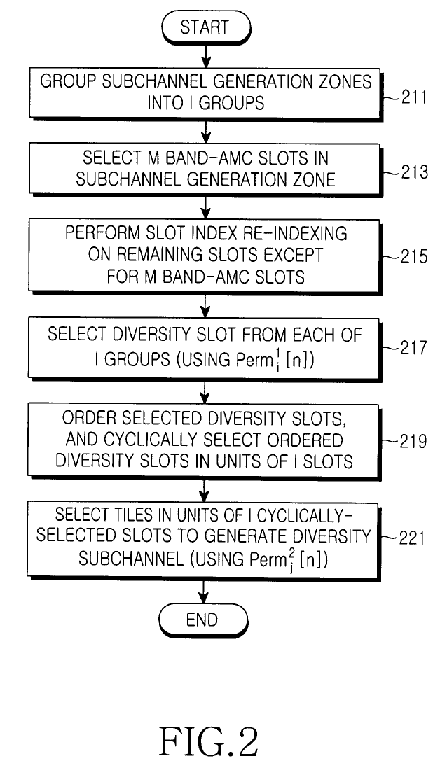

FIG. 2 illustrates a process of generating subchannels at a BS in an OFDMA communication system according to an exemplary embodiment of the present invention.

In an exemplary embodiment as described in FIG. 2, it will be assumed that one subchannel includes at least one subcarrier in the OFDMA communication system. Further, in the OFDMA communication system, one tone indicates a time domain—frequency domain 2-dimensional zone occupied by one subcarrier for one Orthogonal Frequency Division Multiplexing (OFDM) symbol interval and one slot indicates a time domain—frequency domain 2-dimensional zone occupied by one subchannel for one OFDM symbol interval. For convenience, the ‘time domain—frequency domain 2-dimensional zone’ will be referred to herein as a ‘2-dimensional zone’ for short.

Further, in the OFDMA communication system, one tile indicates a 2-dimensional zone occupied by 3 subcarriers for a 3-OFDM symbol interval, or a 2-dimensional zone occupied by 4 subcarriers for a 3-OFDM symbol interval. Herein, the tile, or 2-dimensional zone, occupied by 3 subcarriers for a 3-OFDM symbol interval will be referred to as a ‘first-type tile’, and the tile, or 2-dimensional zone, occupied by 4 subcarriers for a 3-OFDM symbol interval will be referred to as a ‘second-type tile’. While the first-type tile includes 8 data tones and one pilot tone, the second-type tile includes 8 data tones and 4 pilot tones.

Referring to FIG. 2, in step 211, a BS groups all slots i.e., J slots, with which it will generate band-AMC subchannels and diversity subchannels, into I (for example, I=4) groups. For convenience, a zone including all slots with which the BS will generate the band-AMC subchannels and the diversity subchannels will be referred to as a ‘subchannel generation zone’. When j is defined as slot indexes of slots included in a subchannel generation zone, j 0, . . . , J−1, and when i is defined as group indexes, i=0 . . . , I−1. The reason why the BS groups the subchannel generation zone into, for example, 4 groups is because one subchannel includes 4 tiles as described above. When the subchannel generation zone is grouped into 4 groups, the 4 groups can be either equal or different in terms of the number of slots included therein. In addition, the number of slots included in an i^{th} group will be defined as Nₛₗₒₜ[i] (where i=0, 1, 2, 3).

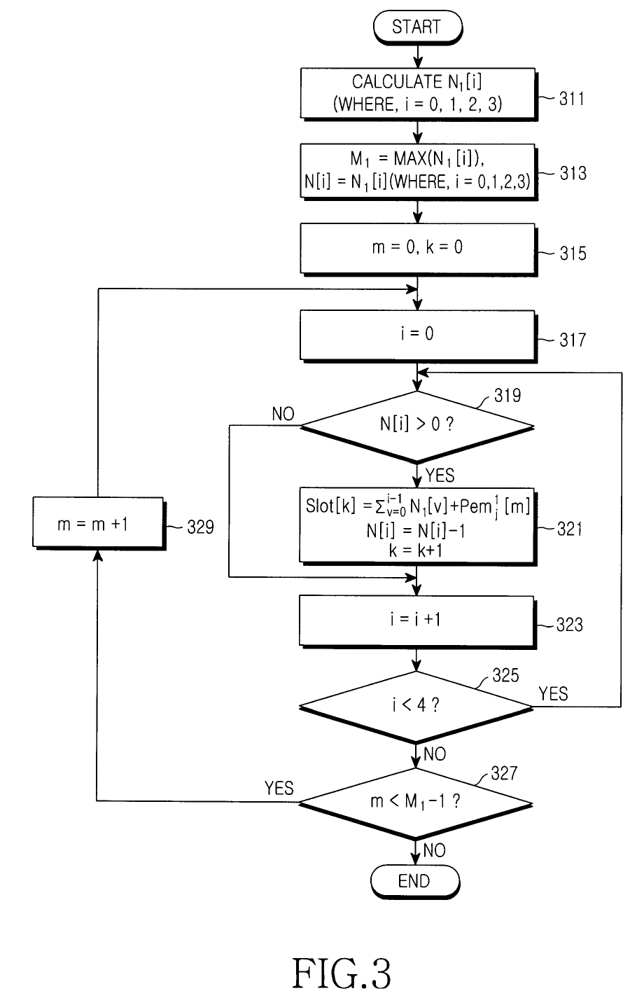

In step 213, the BS selects M slots with which it will generate a band-AMC subchannel in the subchannel generation zone. For convenience, the slot with which the BS will generate a band-AMC subchannel will be referred to herein as a ‘band-AMC slot’. The number M of band-AMC slots is subject to change according to the system condition of the OFDMA communication system. However, when more than 2 slots are selected as the band-AMC slots (M>2), the more than 2 band-AMC slots should be set such that they should not be physically consecutive, taking into account frequency diversity gain of a diversity subchannel. That is, when selecting more than 2 band-AMC slots in the subchannel generation zone, the BS selects physically inconsecutive band-AMC slots. For the M band-AMC slots, it does not matter to which of the 4 groups they belong. In step 215, the BS performs slot index re-indexing on the remaining slots, i.e., Nₛₗₒₜ[0]+Nₛₗₒₜ[1]+Nₛₗₒₜ[2]+Nₛₗₒₜ[3]−M slots, determined by excepting the M band-AMC slots from the subchannel generation zone. That is, since indexes of the slots included in the subchannel generation zone were 0, J−1, the BS again generates the slot indexes 0, . . . , J−1−M for the Nₛₗₒₜ[0]+Nₛₗₒₜ[1]+Nₛₗₒₜ[2]+Nₛₗₒₜ[3]−M slots. In step 217, the BS selects N_{diversity}[i] (where i=0, 1, 2, 3) slots from each of the 4 groups to generate a diversity subchannel. A value of N_{diversity}[i] can be either equal or different. For convenience, the slot with which the BS will generate a diversity subchannel will be referred to herein as a ‘diversity slot’. The operation of selecting N_{diversity}[i] slots from each of the 4 groups for the diversity subchannel generation is performed according to a predetermined permutation sequence permᵢ¹[m] and a detailed description thereof will be given below with reference to FIG. 3.

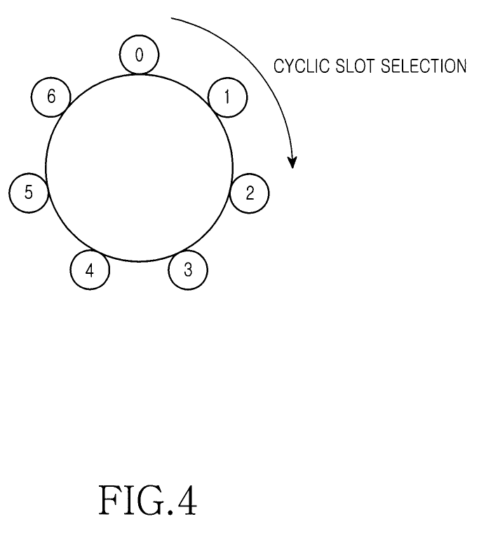

In step 219, the BS orders the Slot[k] (where k=0, . . . , N_{diversity}[0]+N_{diversity}[1]+N_{diversity}[2]+N_{diversity}[3]−1) slots selected from each of the 4 groups to generate a diversity subchannel, cyclically selects the ordered slots in units of 4 slots to generate a diversity subchannel. The reason why the BS cyclically selects the slots in units of 4 slots is because one diversity subchannel includes 4 tiles. The operation of cyclically selecting the ordered slots in units of 4 slots will be described in detail below with reference to FIG. 4. In step 221, the BS selects one tile from each of the 4 selected slots in units of the 4 cyclically selected slots, generates a diversity subchannel using them and then ends the operation. The operation of selecting one tile from each of the 4 selected slots is performed according to a predetermined permutation sequence permⱼ²[n].

Next, with reference to FIG. 3, a detailed description will be given of an exemplary operation of step 217 in FIG. 2.

FIG. 3 illustrates an exemplary operation of step 217 in FIG. 2.

Before a description of FIG. 3 is given, it is noted that the operation of step 217 is for selecting N_{diversity}[i] (where i=0, 1, 2, 3) diversity slots from each of the 4 groups.

Referring to FIG. 3, in step 311, the BS calculates the number N₁[i] of slots obtained by excepting the band-AMC slots from the slots included in an i^{th} group. N₁[i] can be expressed as Equation (1).

N₁[i]=Nₛₗₒₜ[i]−N_{band-AMC}[i] (1)

In Equation (1), N_{band-AMC}[i] (where i=0, 1, 2, 3) denotes the number of band-AMC slots included in an i^{th} group. In step 313, the BS sets values of a parameter M₁ and a parameter N[i] (where i=0, 1, 2, 3). The parameter M₁ is herein set to the maximum value of N[i] (M₁=MAX(N₁[i])), and the parameter N[i] is set to N₁[i] (N[i]=N₁[i] (where i=0, 1, 2, 3)). In step 315, the BS sets values of a parameter m and a parameter k. The parameters m and k each are each set to 0 (m=0, k=0). In step 317, the BS sets a value of a parameter i. In the illustrated exemplary embodiment, the parameter i is set to 0 (i=0). In step 319, the BS determines whether a value of the parameter N[i] exceeds 0 (N[i]>0). If it is determined that the value of the parameter N[i] does not exceed 0, the BS proceeds to step 323. However, if it is determined in step 319 that the value of the parameter N[i] exceeds 0, the BS proceeds to step 321 where it selects a k^{th} diversity slot slot[k] as defined in Equation (2), subtracts 1 from the value of N[i] (N[i]=N[i]−1) and adds 1 to a value of k (k=k+1).

$$slot [ k ] = {\sum }_{v = 0}^{i - 1} {N}_{1} [ v ] + {perm}_{i}^{1} [ m ] \qquad ( 2 )$$

In Equation (2), N₁[v] denotes the number of slots obtained by excepting the band-AMC slots from the slots included in a v^{th} group (where v=0, . . . , i−1), and permᵢ¹[m] denotes a permutation sequence of an i^{th} group. Herein, permᵢ¹[m] is a sequence indicating an m^{th} numeral in a series of randomly arranged numerals of 1 through N₁[i].

In step 323, the BS increases a value of i by 1 (i=i+1). In step 325, the BS determines whether a value of the parameter i is less than 4 (i<4). If it is determined that the value of the parameter i is less than 4, the BS returns to step 319. However, if it is determined in step 325 that the value of the parameter i is not less than 4, the BS proceeds to step 327 where it determines whether a value of the parameter m is less than M₁−1 (m<M₁−1). If it is determined that the value of the parameter m is not less than M₁−1, the BS proceeds to step 329 where it increases a value of the parameter m by 1 (m=m+1) and then returns to step 317. However, if it is determined in step 327 that the value of the parameter m is less than M₁−1, the BS ends selection of the diversity slot.

Next, with reference to FIG. 4, a detailed description will be given of an exemplary operation of step 219 in FIG. 2.

FIG. 4 schematically illustrates an exemplary operation of step 219 in FIG. 2.

Before a description of FIG. 4 is given, it is noted that the operation of step 219 is for ordering the slots, i.e., N_{diversity}[0]+N_{diversity}[1]+N_{diversity}[2]+N_{diversity}[3] slots, selected from each of 4 groups to generate a diversity subchannel and cyclically selecting the ordered slots in units of 4 slots to generate the diversity subchannel.

Referring to FIG. 4, if it is assumed that the selected N_{diversity}[0]+N_{diversity}[1]+N_{diversity}[2]+N_{diversity}[3] slots are ordered in order of 0, 1, 2, 3, 4, 5, 6 according to their slot indexes, indexes of the slots selected to generate a diversity subchannel are cyclically selected as defined in Equation (3).

{0,1,2,3},{4,5,6,0},{1,2,3,4},{5,6,0,1},{2,3,4,5},{6,0,1,2},{3,4,5,6} (3)

Since the number N_{diversity}[0]+N_{diversity}[1]+N_{diversity}[2]+N_{diversity}[3] of slots selected to generate a diversity subchannel as described above is 7 (N_{diversity}[0]+N_{diversity}[1]+N_{diversity}[2]+N_{diversity}[3]=7), the number of generatable diversity subchannels is also 7. Therefore, as shown in Equation (3), the slot indexes each are selected a total of 4 times. After cyclically selecting the slots selected to generate a diversity subchannel in units of 4 slots in this way, the BS selects one tile from each of the 4 cyclically selected slots according to a permutation sequence permⱼ²[n]. For example, permⱼ²[n] is a permutation sequence used for randomly selecting a length-4 sequence of 0, 1, 2, 3.

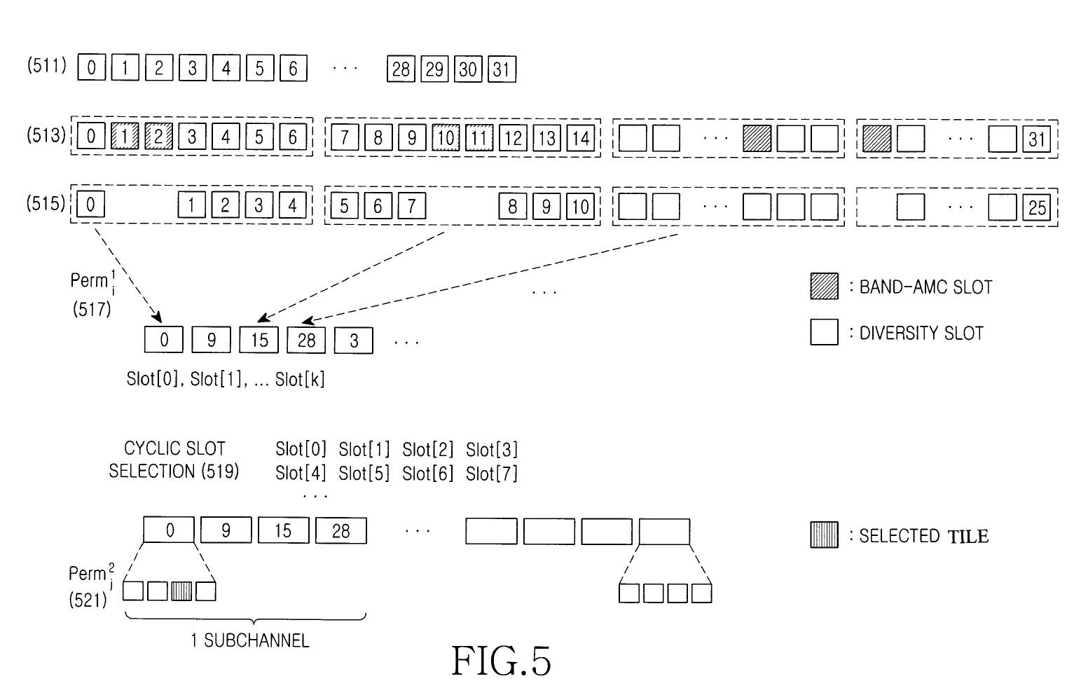

Next, with reference to FIG. 5, a description will now be made of a process in which a BS generates a subchannel in an OFDMA communication system according to an exemplary embodiment of the present invention.

FIG. 5 illustrates a process in which a BS generates a subchannel in an OFDMA communication system according to an exemplary embodiment of the present invention.

Referring to FIG. 5, a BS defines the number of slots included in a subchannel generation zone as a total of 32 slots #0 to #31 (J=32) in step 511. The BS groups the 32 slots into 4 groups (I=4), and selects 6 band-AMC slots from the subchannel generation zone (M=6) in step 513. Because the 6 slots are selected as band-AMC slots in this way, the remaining 26 slots become diversity slots (N_{diversity}[0]+N_{diversity}[1]+N_{diversity}[2]+N_{diversity}[3]=26). Thereafter, the BS performs slot index re-indexing on the remaining slots, i.e., 26 diversity slots, obtained by excepting the band-AMC slots from the 4 groups in step 515. Therefore, for the remaining 26 diversity slots, their slot indexes undergo re-indexing and become slots #0 to #25 after undergoing slot index re-indexing. Thereafter, the BS selects N_{diversity}[i] slots from each of the 4 groups according to a permutation sequence permᵢ¹[m] as described in FIG. 3 in step 517. The BS cyclically selects the diversity slots selected according to the permutation sequence permᵢ¹[m], in units of 4 slots, and orders them in step 519. The BS selects one tile in units of the 4 cyclically selected slots according to a permutation sequence permⱼ²[n] to generate one diversity subchannel in step 521. The BS performs a diversity subchannel generation operation on all of the 26 diversity slots in the above described manner, thereby generating a total of 26 diversity subchannels.

In FIG. 5, the 4 groups can be either equal or different in terms of the number of slots included therein.

As is apparent from the foregoing description, exemplary embodiments of the present invention can generate the band-AMC subchannels and the diversity subchannels in the same zone in an OFDMA communication system.

While the invention has been shown and described with reference to a exemplary embodiment thereof, it will be understood by those skilled in the art that various changes in form and details may be made therein without departing from the spirit and scope of the invention as defined by the appended claims and their equivalents.

What is claimed is:

1. A method for generating a subchannel in a communication system, the method comprising:
grouping J slots, included in a subchannel generation zone, into I groups;
selecting, from the J slots, M band-Adaptive Modulation and Coding (AMC) slots with which a band-AMC subchannel is to be generated;
selecting J-M slots as diversity slots with which a diversity subchannel is to be generated;
generating the band-AMC subchannel using the M slots; and
generating the diversity subchannel using the J-M slots.

2. The method of claim 1, wherein the selecting of the M band-AMC slots comprises selecting more than 2 slots that are physically inconsecutive as the band-AMC slots.

3. The method of claim 1, wherein the grouping of the J slots into I groups comprises grouping the J slots into 4 groups.

4. The method of claim 3, wherein the selecting of the J-M slots as the diversity slots comprises selecting N_{diversity}[i] slots, wherein i=0, 1, 2, 3, from each of the 4 groups to generate the diversity subchannel.

5. The method of claim 4, wherein the selecting of the J-M slots further comprises determining N₁[i] using the equation
N₁[i]=Nₛₗₒₜ[i]−N_{band-AMC}[i],
wherein Nₛₗₒₜ[i] denotes the number of slots in an i^{th} group and N_{band-AMC}[i] denotes the number of band-AMC slots included in an i^{th} group, wherein i=0, 1, 2, 3.

6. The method of claim 5, wherein the selecting of the J-M slots further comprises:
determining if N₁[i] is greater than 0;
selecting a k^{th} diversity slot slot[k] using the equation
$$slot [ k ] = {\sum }_{v = 0}^{i - 1} {N}_{1} [ v ] + {perm}_{i}^{1} [ m ]$$
wherein N₁[v] denotes the number of slots obtained by excepting the band-AMC slots from the slots included in a v^{th} group (where v=0, . . . , i−1) and permᵢ¹[m] denotes a permutation sequence of an i^{th} group indicating an m^{th} numeral in a series of randomly arranged numerals of 1 through N₁[i].

7. The method of claim 1, wherein the generating the diversity subchannel using the J-M slots comprises:
performing slot index re-indexing on the J-M slots;
selecting the J-M slots that underwent slot index re-indexing according to a first permutation sequence;
ordering the J-M selected slots;
cyclically selecting the J-M ordered slots in units of I slots;
selecting a tile included in a corresponding slot in units of the I cyclically selected slots according to a second permutation sequence; and
generating a diversity subchannel using the tile selected for each of the I slots.

8. The method of claim 7, wherein one slot is a time domain—frequency domain 2-dimensional zone occupied by one subchannel for one Orthogonal Frequency Division Multiplexing (OFDM) symbol interval.

9. The method of claim 1, wherein the communication system comprises at least one of an IEEE 802.16 communication system, a Mobile WiMAX communication system and an IEEE 802.20 communication system.

10. An apparatus for generating a subchannel in a communication system, the apparatus comprising:
a Base Station (BS) for;
grouping J slots included in a subchannel generation zone into I groups;
for selecting, from the J slots, M band-Adaptive Modulation and Coding (AMC) slots with which a band-AMC subchannel is to be generated;
for selecting (J-M) slots as diversity slots with which a diversity subchannel is to be generated; and
for generating the band-AMC subchannel using the M slots, and for generating the diversity subchannel using the J-M slots.

11. The apparatus of claim 10, wherein the selecting of the M band-AMC slots comprises selecting more than 2 slots as the band-AMC slots, wherein the more than 2 slots are physically inconsecutive.

12. The apparatus of claim 10, wherein the grouping of the J slots into I groups comprises grouping the J slots into 4 groups.

13. The apparatus of claim 12, wherein the selecting of the J-M slots as the diversity slots comprises selecting N_{diversity}[i] slots, wherein i=0, 1, 2, 3, from each of the 4 groups to generate the diversity subchannel.

14. The apparatus of claim 13, wherein the selecting of the J-M slots further comprises determining N₁[i] using the equation
N₁[i]=Nₛₗₒₜ[i]−N_{band-AMC}[i],
wherein Nₛₗₒₜ[i] denotes the number of slots in an i^{th} group and N_{band-AMC}[i] denotes the number of band-AMC slots included in an i^{th} group, wherein i=0, 1, 2, 3.

15. The apparatus of claim 14, wherein the selecting of the J-M slots further comprises:
determining if N₁[i] is greater than 0;
selecting a k^{th} diversity slot slot[k] using the equation
$$slot [ k ] = {\sum }_{v = 0}^{i - 1} {N}_{1} [ v ] + {perm}_{i}^{1} [ m ]$$
wherein N₁[v] denotes the number of slots obtained by excepting the band-AMC slots from the slots included in a v^{th} group (where v=0 . . . , i−1) and permᵢ¹[m] denotes a permutation sequence of an i^{th} group indicating an m^{th} numeral in a series of randomly arranged numerals of 1 through N₁[i].

16. The apparatus of claim 10, wherein the BS:
performs slot index re-indexing on the J-M slots, selects the J-M slots that underwent slot index re-indexing according to a first permutation sequence, and orders the J-M selected slots, cyclically selects the J-M ordered slots in units of I slots, selects a tile included in a corresponding slot in units of the I cyclically selected slots according to a second permutation sequence and generates a diversity subchannel using the tile selected for each of the I slots.

17. The apparatus of claim 16, wherein one slot is a time domain—frequency domain 2-dimensional zone occupied by one subchannel for one Orthogonal Frequency Division Multiplexing (OFDM) symbol interval.

18. The apparatus of claim 10, wherein the communication system comprises at least one of an IEEE 802.16 communication system, a Mobile WiMAX communication system and an IEEE 802.20 communication system.
